(19) United States
(12) Patent Application Publication
(10) Pub. No.: US 2002/0085370 A1
(43) Pub. Date: Jul. 4, 2002

(54) Plate-frame for electric and electronic mechanisms

(76) Inventor: Joaquin Aubert Capella, Barcelona (ES)

Correspondence Address: Striker, Striker & Stenby, 103 East Neck Road, Huntington, NY, 11743, US

(21) Appl. No.: 09/982,603

(22) Filed: Oct. 18, 2001

(30) Foreign Application Priority Data
Oct. 25, 2000 (ES) 200002602

(51) Int. Cl. F21V 9/16

(52) U.S. Cl. 362/84; 362/95; 362/29

(57) ABSTRACT

A illuminable plate-frame assembly for drive elements on electric and electronic mechanisms includes a plate-frame made of translucent or transparent material and a mounting plate having a central embossment. The plate-frame is formed so as to interlockingly engage the central embossment. An electroluminescent sheet is disposed between the plate-frame and the mounting plate, with the electroluminiscent sheet extending to the perimeters of the plate-frame and the mounting plate when the plate-frame and said mounting plate are fitted together. The assembly also includes means for providing an electric current to said electroluminescent sheet, such as a connector, which in turn, is connected to an energy source on the mechanism. The electric current triggers the electroluminescent sheet and causes a luminic release, which illuminates the plate-frame assembly so that an observer can determine the position and location of the plate-frame assembly and the drive mechanism positioned within the plate-frame assembly.

### BACKGROUND OF THE INVENTION

The present invention relates to plate-frames used for protection and external finish of common electric and electronic mechanisms, such as switches, pushbuttons, mounting plates, prong plugs and the like, used in touch-operated devices or installations.

More particularly, the present invention relates to a plate-frame assembly for electric and electronic mechanisms, the plate-frame assembly having an electroluminiscent element which, when triggered, provides a luminescent flow which allows the plate-frame, thus enabling an operator of the mechanism to readily determine the position and location of the elements located within the perimeter of the plate-frame. The present invention is contemplated for used with electric or electronic mechanisms used in the home as well as with industrial wiring of low or medium voltage, and is also suitable for used in installations for internal transmission of data or the like.

### SUMMARY OF THE INVENTION

One object of the present invention is to provide a plate-frame assembly with an electroluminescent device for externally finishing an electric or electronic mechanism, such that the electric or electronic mechanism can be easily seen in the dark, as well as in an environment having reduced visibility either because of a lack of proper illumination or because of the presence of fumes or gas in the air. The inventive plate-frame assembly therefore allows the mechanism to be immediately located in these kinds of conditions, and allows an operator of the mechanism to trigger or activate the mechanism without unnecessary delays in the feeding and connecting of electric or electronic networks, such as, for example, the type used for transmitting data through fiber optic cable and the like.

As noted above, the plate-frame assembly of the present invention includes an element which, when triggered by the passage of an electric flux, will provide a given luminic release, or luminescent output. This element preferably is of the kind known as “electroluminisent”, that is, luminescence which occurs by excitations of the electric type, a phenomenon having a high energetic performance because it provides a luminic release virtually without any heat release. This release of light is commonly known as “cold light”, in that the element is excitable due to the passage of an electric current to produce strictly luminic release without producing any heat. This “cold light” phenomenon has been found to be suitable for providing a luminescent flux in places where this flux must be constantly maintained while avoiding any heat production. This elimination of associated heating thus eliminates risks of accident or failure associated with such heating.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is an exploded, perspective view of the various elements of the plate-frame assembly of the present invention;

FIG. 2 is a sectional, side elevation view of the assembled elements of the plate-frame assembly of the present invention; and

FIG. 3 is a detail of FIG. 2, shown at a larger scale than FIG. 2, illustrating the end area of the assembled plate-frame assembly.

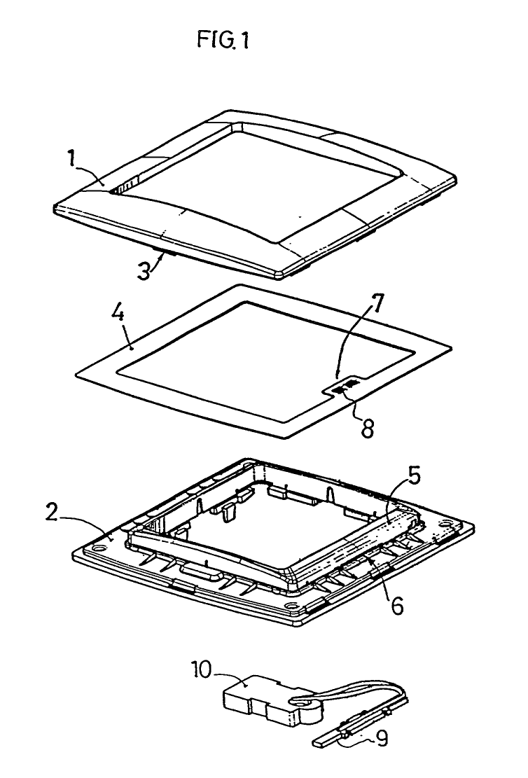

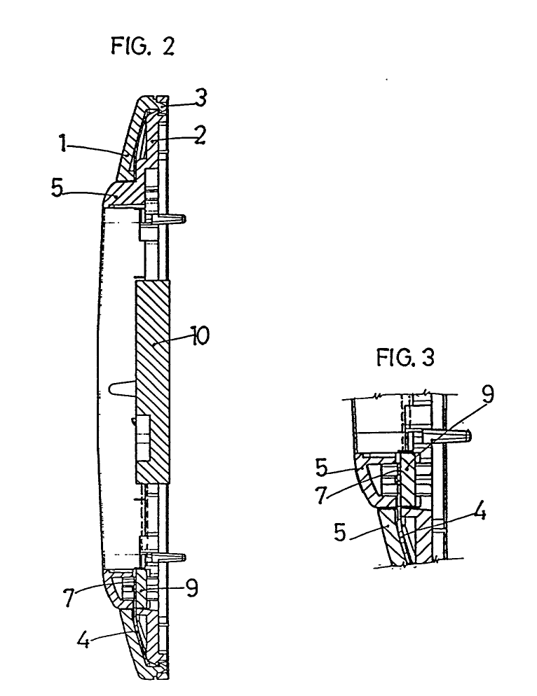

### DESCRIPTION OF THE PREFERRED EMBODIMENTS

As shown in the accompanying figure, the plate-frame assembly for electric and electronic mechanisms, has a plate-frame 1, preferably having a quadrangular or rectangular shape, although other shapes obviously can be employed to the same effect. The plate-frame 1 can be made of translucent or transparent material, which can be colored or uncolored, depending on the requirements. The assembly also includes a mounting plate 2, onto which the plate is fitted and locked by means of perimetric rims 3 disposed on the plate-frame 1.

An electroluminiscent sheet 4 is disposed between the plate-frame 1 and the mounting plate 2. The electroluminescent sheet 4 has an outer shape or contour corresponding to that of the mounting plate 2. An internal outline or contour on the sheet 4 corresponds with a quadrangular embossment 5 on the mounting plate 2, which serves to fasten and retain in place both the plate-frame 1 and the electroluminscent sheet 4. The sheet 4 further includes a tab or rim 7 disposed on a side of the sheet 4.

The embossment 5 has a slot 6 disposed on a side, into which the tab or rim 7 is introduced, the tab 7 having graphite contacts 8 for connecting the rim 7 to the contact element 9 of a connector element 10. The connector 10 is positioned in the internal part of the electric or electronic mechanism so that is always contacts the area of the permanently fed contacts of the mechanism. For this reason, the electroluminiscent sheet 4 also will remain permanently triggered. This triggering provokes a release of luminic energy from the entire sheet 4, producing a light which becomes visible to the observer through the translucent or transparent plate-frame 1. This visible light thereby illuminates for the observer the location of the plate-frame assembly, including the plate-frame 1 and the central embossment 5 of the mounting plate 2, the assembly mounted about the element for driving the mechanism (i.e., the pushbutton, switch, or the like) such that the driving mechanism is disposed within the central recess of the mounting plate.

While the invention has been illustrated and described as a plate-frame assembly for an electric or electronic mechanism, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A illuminable plate-frame assembly for drive elements on electric and electronic mechanisms, comprising:
a plate-frame comprising translucent or transparent material;
a mounting plate having a central embossment, said plate-frame adapted to be mounted for interlockingly fitting onto said central embossment;
an electroluminescent sheet disposed between said plate-frame and said mounting plate, wherein said electroluminiscent sheet extends to perimeters of said plate-frame and said mounting plate when said plate-frame and said mounting plate are fitted together with said electroluminescent sheet disposed therebetween;
means for providing an electric current to said electroluminescent sheet, wherein said electric current triggers said electroluminescent sheet and causes a luminic release, said luminic release thereby illuminating said plate-frame assembly so that an observer can determine the position and location of said plate-frame assembly and said drive mechanism positioned within said plate-frame.

2. The plate-frame assembly according to claim 1, wherein said electroluminescent sheet has a projecting tab on a side thereof and said mounting plate has a slot for receiving said tab when said electroluminescent sheet is disposed between said plate-frame and said mounting plate, said tab having at least one graphite contact for continuously contacting a connector on said mechanism, whereby said graphite contact is continuously supplied with an electric current, thereby providing said electroluminiscent sheet with a continuous electric current for triggering and producing said luminic release.
